(19) United States
(12) Patent Application Publication
(10) Pub. No.: US 2014/0351354 A1
(43) Pub. Date: Nov. 27, 2014

(54) METHOD AND APPARATUS FOR SHARING POINT OF INTEREST INFORMATION AS A WEBLINK

(71) Applicant: Nokia Corporation, Espoo (FI)

(72) Inventors: Umesh Chandra, Sunnyvale, CA (US); Madhavi Latha Padakanti, Bangalore (IN)

(21) Appl. No.: 14/367,215

(22) PCT Filed: Dec. 13, 2012
(86) PCT No.: PCT/FI2012/051234

§ 371 Date: Jun. 19, 2014

(30) Foreign Application Priority Data
Dec. 29, 2011 (IN) 4653/CHE/2011

(51) Int. Cl. H04L 29/06; H04L 12/58

(52) U.S. Cl. CPC H04L 65/403; H04L 51/046
USPC 709/206; 709/204

(57) ABSTRACT

An approach is provided for facilitating the sharing of information related to an item of interest as a web link via data messaging. The messaging client determines a request to share information related to an item of interest. The messaging client then causes an encoding of the information, geo-coded information, sharing destinations, and user credentials for the sharing destinations into a communication. The messaging client further causes a transmission of the communication to a web server. Next, the message platform determines a request to create a web link for sharing information related to an item of interest, wherein the request includes a communication encoding the information, sharing destinations, and user credentials. The message platform then processes and/or facilitates a processing of the request to cause a creation of a web link based on the communication. The message platform further determines to make the web link available to the sharing destinations.

### BACKGROUND

Service providers and device manufacturers (e.g., wireless, cellular, etc.) are continually challenged to deliver value and convenience to consumers by, for example, providing compelling network services. One area of interest has been the development of services that enable mobile device users to search, review, and make recommendations regarding an item or point of interest (POI). More specifically, there is an interest is incorporating these functions with social networking services so that users can share their individual searches, reviews, and/or recommendations with their friends, family, and/or associates. Today's mobile devices (e.g., mobiles phones and/or smartphones) typically have data services (e.g., general packet radio services (GPRS)) that provide connectivity to the Internet for access to various search engines and social networking services. However, in emerging markets, GPRS or other data services can be expensive. Accordingly, many users in such markets limit their communications to voice and standard messaging services (e.g., short message service (SMS), multimedia messaging service (MMS), etc.), thereby potentially limiting their ability to engage more advance POI related services. For example, text messaging services are typically limited to 140-160 characters per text message, which makes sharing information related to an item of interest via one or more text messages cumbersome. Accordingly, services providers and device manufacturers face significant technical challenges to provide users in emerging markets with the ability to share information (e.g., promotional information related to specific POIs) via one or more data messaging services.

### SOME EXAMPLE EMBODIMENTS

Therefore, there is a need for an approach for facilitating the sharing of information related to an item of interest as a web link that can be initiated by a communication that is compatible with and/or can be transmitted by standard messaging protocols (e.g., SMS, MMS, other data messages, etc.).

According to one embodiment, a method comprises determining a request to share information related to at least one item of interest. The method also comprises causing, at least in part, an encoding of the information, geo-coded information, one or more sharing destinations, one or more user credentials for the one or more sharing destinations, or a combination thereof into at least one communication. The method further comprises causing, at least in part, a transmission of the at least one communication to a web server.

According to another embodiment, an apparatus comprises at least one processor, and at least one memory including computer program code for one or more computer programs, the at least one memory and the computer program code configured to, with the at least one processor, cause, at least in part, the apparatus to determine a request to share information related to at least one item of interest. The apparatus is also caused to cause, at least in part, an encoding of the information, geo-coded information, one or more sharing destinations, one or more user credentials for the one or more sharing destinations, or a combination thereof into at least one communication. The apparatus is further caused to cause, at least in part, a transmission of the at least one communication to a web server.

According to another embodiment, a computer-readable storage medium carries one or more sequences of one or more instructions which, when executed by one or more processors, cause, at least in part, an apparatus to determine a request to share information related to at least one item of interest. The apparatus is also caused to cause, at least in part, an encoding of the information, geo-coded information, one or more sharing destinations, one or more user credentials for the one or more sharing destinations, or a combination thereof into at least one communication. The apparatus is further caused to cause, at least in part, a transmission of the at least one communication to a web server.

According to another embodiment, an apparatus comprises means for determining a request to share information related to at least one item of interest. The apparatus also comprises means for causing, at least in part, an encoding of the information, geo-coded information, one or more sharing destinations, one or more user credentials for the one or more sharing destinations, or a combination thereof into at least one communication. The apparatus further comprises means for causing, at least in part, a transmission of the at least one communication to a web server.

According to one embodiment, a method comprises determining a request to create at least one web link for sharing information related to at least one item of interest, wherein the request includes at least one communication encoding the information, one or more sharing destinations, one or more user credentials for the one or more sharing destinations, or a combination thereof. The method also comprises processing and/or facilitating a processing of the request to cause, at least in part, a creation of the at least one web link based, at least in part, on the at least one communication. The method further comprises determining to make the at least one web link available to the one or more sharing destinations.

According to another embodiment, an apparatus comprises at least one processor, and at least one memory including computer program code for one or more computer programs, the at least one memory and the computer program code configured to, with the at least one processor, cause, at least in part, the apparatus to determine a request to create at least one web link for sharing information related to at least one item of interest, wherein the request includes at least one communication encoding the information, one or more sharing destinations, one or more user credentials for the one or more sharing destinations, or a combination thereof. The apparatus is also caused to process and/or facilitate a processing of the request to cause, at least in part, a creation of the at least one web link based, at least in part, on the at least one communication. The apparatus is further caused to determine to make the at least one web link available to the one or more sharing destinations.

According to another embodiment, a computer-readable storage medium carries one or more sequences of one or more instructions which, when executed by one or more processors, cause, at least in part, an apparatus to determine a request to create at least one web link for sharing information related to at least one item of interest, wherein the request includes at least one communication encoding the information, one or more sharing destinations, one or more user credentials for the one or more sharing destinations, or a combination thereof. The apparatus is also caused to process and/or facilitate a processing of the request to cause, at least in part, a creation of the at least one web link based, at least in part, on the at least one communication. The apparatus is further caused to determine to make the at least one web link available to the one or more sharing destinations.

According to another embodiment, an apparatus comprises means for determining a request to create at least one web link for sharing information related to at least one item of interest, wherein the request includes at least one communication encoding the information, one or more sharing destinations, one or more user credentials for the one or more sharing destinations, or a combination thereof. The apparatus also comprises means for processing and/or facilitating a processing of the request to cause, at least in part, a creation of the at least one web link based, at least in part, on the at least one communication. The apparatus further comprises means for determining to make the at least one web link available to the one or more sharing destinations.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of facilitating the sharing of information related to an item of interest as a web link via one or more data messaging services, according to one embodiment;

FIGS. 2A and 2B are diagrams of the components of a messaging client and a message platform, respectively, according to one embodiment;

FIG. 3 is a flowchart of the client side process for facilitating the sharing of information related to an item of interest as a web link via one or more data messaging services, according to one embodiment;

FIG. 4 is a flowchart of the server side process for facilitating the sharing of information related to an item of interest as a web link via one or more data messaging services, according to one embodiment;

FIG. 5 is a diagram of user interfaces utilized in the processes of FIGS. 3 and 4, according to various embodiments;

FIG. 6 is a diagram of an example of a social network service website and a web-based mapping service website utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for facilitating the sharing of information related to an item of interest as a web link via a data messaging service are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

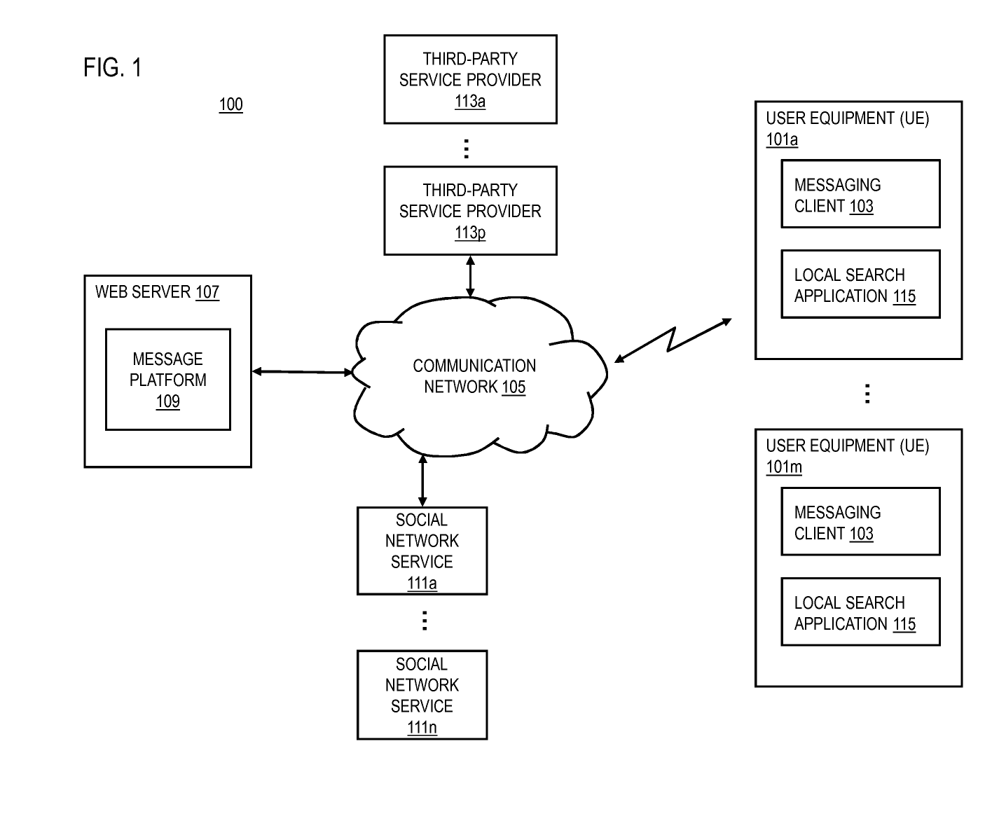

FIG. 1 is a diagram of a system capable of facilitating the sharing of information related to an item of interest as a web link via one or more data messaging services, according to one embodiment. As previously discussed, service providers and device manufacturers are increasingly interested in developing services that enable mobile device users to search, review, and make recommendations regarding an item or point of interest (POI). More specifically, there is an interest in incorporating these functions with social networking services so that users can share their individual searches, reviews, and/or recommendations with their friends, family, and/or associates. Today's mobile devices (e.g., mobile phones and/or smartphones) typically have GPRS that enables users to have mobile access to various search engines and social networking services. However, in emerging markets a majority of users do not have GPRS enabled phones or smartphones and are therefore limited to voice and data messaging services (e.g., SMS, MMS, etc.). Furthermore, SMS messaging services are typically limited to 140-160 characters per SMS message, which makes sharing location information via one or more SMS messages cumbersome. Moreover, in emerging markets users are often limited to using internet cafes and home personal computers in order to access and update location information via one or more social networking services. In addition, the problem of limited access to search engines and social networking services in emerging markets is further compounded for small businesses. In particular, small businesses form the business landscape in emerging markets; however, they rarely have websites and/or a web presence to provide consumers with information about their businesses (e.g., locations, hours, upcoming sales, etc.).

To address this problem, a system 100 of FIG. 1 introduces the capability to share information related to an item of interest as a web link via one or more data messaging services, according to one embodiment. More specifically, the system 100 enables a user to share such information on one or more social networking services (e.g., FACEBOOK, TWITTER, FOURSQUARE, etc.). For example, the system 100 enables a user to select a particular item of interest (e.g., a restaurant) through a local search application or based on physical proximity (e.g., determined by cell-id and/or a Global Position System (GPS)) and share information about that item (e.g., that he or she likes, dislikes, recommends, etc.) with his or her friends, family, and/or associates on one or more social networking services via a data message (e.g., a SMS message).

In one embodiment, the client side of the system 100 encodes and transmits to the server side of the system 100 via a communication network 105 the information related to an item of interest that the user wants to share, location information, geo-coded information, or a combination thereof related to the item of interest, the user's selection of one or more social networking services used to share the information, and the user's social network credentials via a data message service (e.g., a SMS message). For example, the system 100 may prompt the user to send a predefined text message using his or her mobile device (e.g., mobile phone) as follows: “1 for like,” “2 for dislike,” “3 for check-in,” “4 for FACEBOOK,” “5 for TWITTER,” and so forth. The client side of the system 100 then sends the SMS message to a number that is already hard-coded in the client (e.g., an SMS client) and that corresponds to a particular SMS gateway associated with the system 100. Once the SMS gateway provider receives the user's SMS message, the SMS message is forwarded to the server side of the system 100 via Hypertext Transfer Protocol (HTTP) via the communication network 105. Once the web server of the system 100 receives the SMS message, the system 100 is able to determine based, at least in part, on the content of the SMS message from which user the SMS message originated and which social network service the user wants to share his or her information about the item of interest. The system 100 then creates a web link (e.g., a Uniform Resource Locator (URL) link) that references a particular internet resource (e.g., a web-based mapping service) and geo-coded information related to the item of interest (e.g., the restaurant's name, address, phone number, etc.), which the server side of the system 100 obtained from the client side of the system 100 and/or one or more third-party providers via the communication network 105. Further, the system 100 causes the web link to be published or posted on the one or more social networking services selected by the user so that it appears “User XYZ likes restaurant ABC” on the one or more social networking services and the “ABC” portion of the web link appears to function as a hyperlink. Accordingly, a user of the one or more social networking services is able to view the information the original user wanted to share related to item of interest and can interact with the web link, which in this instance will automatically locate the item of interest on the web-based mapping service along with the additional geo-coded information related to the item of interest.

In addition to sharing a particular user's likes/dislikes regarding an item of interest, the system 100 is also capable of various other functions. For example, the system 100 can enable a user to share an interesting location that he or she recently visited with one or more friends; record an item of interest (e.g., a shop or a restaurant) for later reference; provide directions to an item of interest (e.g., a temple, church, hospital, police station, etc.) to friends, family, and/or associates; and can also function as a business model (e.g., sharing prime locations from a mobile device to the web).

In another embodiment, the system 100 can encode and transmit the information related to an item of interest that the user wants to share via a general packet radio service (GPRS) message, a multimedia messaging service (MMS) message, a data message, or a combination thereof. For example, if the user's mobile device (e.g., mobile phone) is equipped with a camera and contains at least one client configured for MMS, the user can share a photograph related to the item of interest (e.g., the exterior of a restaurant or a plate of food) along with the other information related to that item of interest. In this instance, the client side of the system 100 encodes and transmits the information related to an item of interest that the user wants to share, location information, geo-coded information, or a combination thereof related to an item of interest, the user's selection of one or more social networking services, and the user's social network credentials as a MMS message to the server side of the system 100 via the communication network 105. The system 100 then stores the content of the MMS message and makes it available as a web link (e.g., a dynamically generated URL link), which the system 100 also associates with a particular internet resource (e.g., a web-based mapping service) and the geo-coded information related to the item of interest obtained from the client side of the system 100 and/or one or more third-party providers via the communication network 105. In this example, when a social network service user clicks on the “ABC” hyperlink, he or she is able to view a photograph related to the item of interest in addition to viewing the item of interest located on the web-based mapping service and related geo-coded information.

In one embodiment, the web link published or posted by the system 100 to one or more social networking services relating to an item of interest is persistent, but the information shared by a user and/or the additional geo-coded information relating to that item of interest may be changed and/or be updated from time to time. For example, in the case of a small business (e.g., restaurant), the owner may want to update his or her weekly lunch specials. Accordingly, if a user of the one or more social networking services clicks on the published or posted web link, the item of interest will still automatically be located on the web-based mapping service, but in this instance the weekly lunch specials will be updated. As a result, the system 100 enables a small business owner in an emerging market to have a web presence.

As shown in FIG. 1, the system 100 comprises one or more user equipment (UE) 101a-101m (also collectively referred to as UEs 101) containing a messaging client 103 (e.g., a SMS client or a MMS client) having connectivity to a web server 107 containing a message platform 109 via a communication network 105. The UEs 101 are also connected with a gateway provider (e.g., a SMS gateway or a MMS gateway) (not shown for illustrative purposes) via a communication network 105. The web server 107 is connected to one or more social networking services 111a-111n (e.g., FACEBOOK, TWITTER, FOURSQUARE, etc.) (also collectively referred to as social network providers 111), one or more third-party service providers 113a-113p (e.g., location-based services and/or POI data providers) (also collectively referred to as third-party service providers 113) via the communication network 105. In one embodiment, the UEs 101 also contain a local search application 115 that connects with the web server 107 via the communication network 105.

In one embodiment, the messaging client 103 determines a request to obtain information related to at least one item of interest and/or a particular location. The item of interest may be determined based on physical proximity or through the use of the local search application 115. More specifically, a user of the UE 101 can specify a category (e.g., Food, Entertainment, etc.) or a keyword (e.g., restaurant ABC) or utilize the physical location of the UE 101 (e.g., determined by cell-id and/or GPS) to discover an item of interest. The category, keyword, or physical location of the UE 101 is transmitted by the message client 103 as a data message (e.g., a SMS message) to the message platform 109 within the web server 107 via the communication network 105. The message platform 109 then determines POI data from the third-party service providers 113 based, at least in part, on the criteria specified by the user or the physical location of the UE 101. The POI data has meta-data associated with it such as a building name, a street name, a landmark reference, an area name, a city name, geo-coordinates, etc. Moreover, the POI data also has information associated with it such an email address, a telephone number, and a website in some cases. The message platform 109 then causes, at least in part, the transmission of the results back to the messaging client 103 and local search application 115 within the UE 101 via the communication network 105. Once the results are obtained by the UE 101, the user could browse through the results and do some sort of action (e.g., call the restaurant directly). In an exemplary embodiment, from the client side perspective, the messaging client 103 determines a request by a user of the UE 101 to share information related to at least one item of interest (e.g., “I like restaurant ABC”) at one or more sharing destinations (e.g., the social networking services 111 and/or the search engines 115). The messaging client 103 then causes, at least in part, an encoding of the information the user wants to share including location information, geo-coded information (e.g., name, address, location, etc. determined by the user and/or the local search application 115), or a combination thereof related to the item of interest, the one or more sharing destinations selected by the user, the one or more user credentials associated with the selected sharing destinations (e.g., login and passwords), or a combination thereof into at least one communication (e.g., a SMS message). For example, the message client 103 can encode the user's request as follows: “ABC,” “1 for like,” “2 for dislike,” “3 for check-in,” “4 for FACEBOOK,” “5 for TWITTER,” and so forth. The message client 103 then causes, at least in part, a transmission of the encoded communication to the message platform 109 within the web server 107 via the communication network 105.

In an exemplary embodiment, from the server side perspective, the message platform 109 within the web server 107 determines a request to share information related to an item of interest (e.g., “I like restaurant ABC”). More specifically, the message platform 109 determines a request to create at least one web link associated with the item and the information a user wants to share. Once the message platform 109 receives the encoded communication from the messaging client 103 via the communication network 105, the message platform 109 decodes the communication to determine from which user the communication came from, the item of interest that the information relates to, location information, geo-coded information, or a combination thereof related to the item of interest, which sharing destination the user wants to publish or post the information to, and the user credentials for the one or more sharing destinations. Based, at least in part, on the identification of the item (e.g., name, address, location, etc. determined by the user or the local search application 115), the message platform 109 determines other information related to the item of interest. More specifically, the message platform 109 determines from one or more third-party service providers 113 (e.g., a web-based mapping service) a portion of a map where the item of interest is located. In one embodiment, the message platform 109 can also determine from one or more third-party service providers 113 (e.g., a POI database provider) additional geo-coded information related to the item (e.g., street name, telephone number, email address, hours of operation, etc.). The message platform 109 then causes, at least in part, a generation of a web link to include, at least in part, an association to the location information, the geo-coded information, one or more services, or a combination thereof. For example, the message platform 109 can generate a web link that reads “user XYZ likes restaurant ABC” and enables a user to interact with the web link, which in this instance will automatically locate the item of interest on a map along with the location and geo-coded information related to the item of interest. As previously discussed, if the UE 101 supports GPRS, MMS, or data channel messages, the message platform 109 could also associate a photograph, a video, or a combination thereof with the generated web link. Further, the message platform 109 determines to make the at least one web link available to one or more sharing destinations selected by the user based, at least in part, on the one or more user credentials. As a result, a user of the one or more sharing destinations can view the fact that “user XYZ likes restaurant ABC” and may even determine additional information related to the restaurant ABC by clicking on the web link. In addition, as previously discussed, a user is also able to use the message client 103 in order to update the information associated with the persistent web link generated by the message platform 109.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101, the messaging client 103, the web server 107, the message platform 109, and the local search application 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

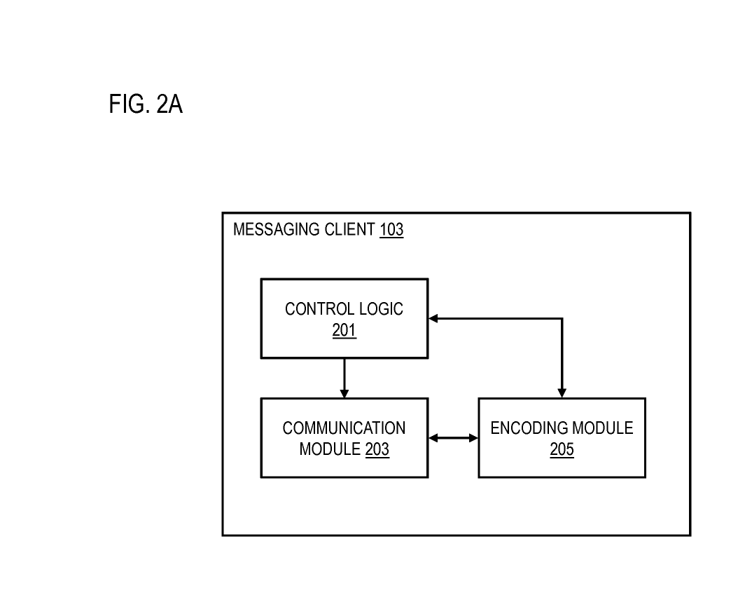

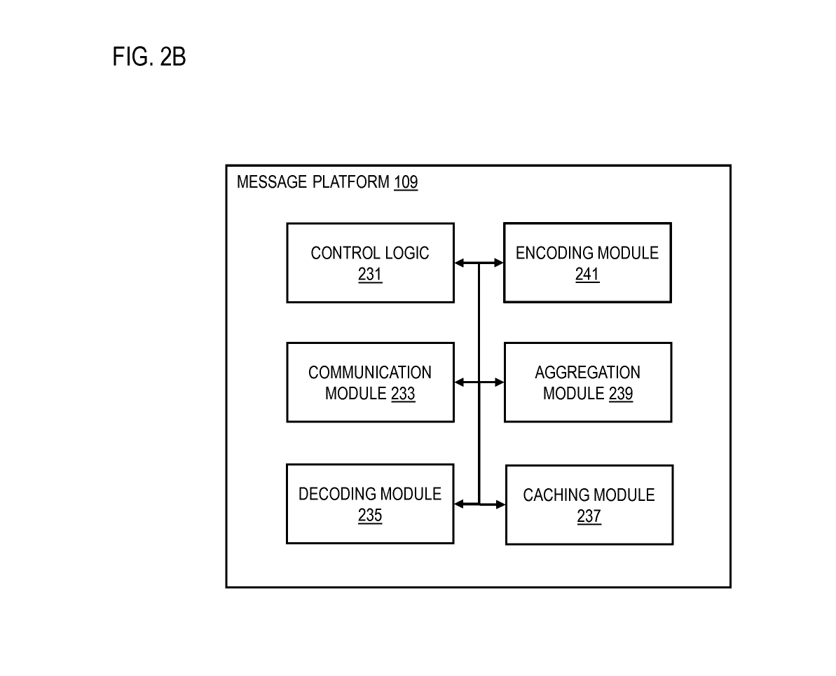

FIG. 2A is a diagram of the components of the messaging client 103, according to one embodiment. By way of example, the messaging client 103 includes one or more client side components for facilitating the sharing of information related to an item of interest via one or more data messaging services. It is contemplated that the functions of these components may be combined in one or more components or performed by other components of equivalent functionality. In this embodiment, the messaging client 103 includes a control logic 201, a communication module 203, and an encoding module 205.

The control logic 201 oversees tasks, including tasks performed by the communication module 203 and the encoding module 205. For example, although the other modules may perform the actual task, the control logic may determine when and how those tasks are performed or otherwise direct the other modules to perform the task.

The communication module 203 is used for communication between the messaging client 103 of the UEs 101 and the message platform 109 of the web server 107. The communication module 203 may be used to communicate commands, requests, data, etc. For example, the communication module 203 may be used to transmit data from the user interface of the UEs 101 (e.g., a alpha-numeric keypad) to the encoding module 205 and/or cause, at least in part, the presentation, render, and/or display of data transmitted from the message platform 109 at the graphical user interface of the UEs 101 (e.g., a display). In addition, the communication module 203 is used to transmit a request to the message platform 109 to create at least one web link to the information that the user wants to share related to the at least one item of interest (e.g., a restaurant). The communication module 203 is also used for communication between the local search application 115 and the message platform 109 of the web server 107. Further, the communication module 203 is used for communication between the encoding module 205 and the message platform 109 of the web server 107.

The encoding module 205 is used to encode the information related to at least one item of interest that a user wants to share (e.g., “I like restaurant ABC”), location information, geo-coded information, or a combination thereof related to the at least one item of interest, the one or more sharing destinations (e.g., FACEBOOK, TWITTER, GOOGLE, etc.), the one or more user credentials for the one or more sharing destinations (e.g., login and passwords), or a combination thereof into at least one communication (e.g., a SMS or a MMS message). For example, the message client 103 can encode the user's request as follows: “ABC,” “1 for like,” “2 for dislike,” “3 for check-in,” “4 for FACEBOOK,” “5 for TWITTER,” and so forth. In another embodiment, the message client can encode the user's request as a predefined message (e.g., “I like this restaurant,” “I like the food at this restaurant,” “I recommend this restaurant,” etc.). As previously discussed, the encoding module 205 may also be used to encode a photograph, a video, or a combination thereof if the UE 101 is compatible with MMS messaging.

FIG. 2B is a diagram of the components of the message platform 109, according to one embodiment. By way of example, the message platform 109 includes one or more server side components for facilitating the sharing of information related to an item of interest as a web link via one or more data messaging services. It is contemplated that the functions of these components may be combined in one or more components or performed by other components of equivalent functionality. In this embodiment, the message platform 109 includes a control logic 231, a communication module 233, a decoding module 235, a caching module 237, an aggregation module 239, and an encoding module 241.

Similar to the control logic 201 of the messaging client 103, the control logic 231 oversees the tasks, including tasks performed by the communication module 233, the decoding module 235, the caching module 237, the aggregation module 239, and the encoding module 241. For example, although the other modules may perform the actual task, the control logic 231 may determine when and how those tasks are performed or otherwise direct the other modules to perform the task.

Similar to the communication module 203 of the messaging client 103, the communication module 233 is used for communication between the message platform 109 of the web server 107 and the messaging client 103 of the UEs 101. The communication module 233 may be used to communicate commands, requests, data, etc. More specifically, the communication module 233 is used for communication between the communication module 203 of the messaging client 103 and the caching module 237.

Similar to the encoding module 205 of the messaging client 103, the decoding module 235 is used to decode at the least one communication (e.g., a SMS or a MMS message) transmitted by the communication module 203 of the messaging client 103 and the communication module 233 of the message platform 109 to determine the identity of the at least one item of interest (e.g., name, address, location) that the user wants to share information about, the information that the user wants to share (e.g., “I like restaurant ABC”), location information, geo-coded information, or a combination thereof related to the at least one item of interest, the one or more sharing destinations (e.g., FACEBOOK, TWITTER, GOGGLE, etc.), and the one or more user credentials for the one or more sharing destinations (e.g., logins and passwords).

The caching module 237 caches the information related to the at least one item of interest after it has been decoded by the decoding module 235. For example, once the decoding module 235 decodes the at least on communication, the information that the user wants to share (e.g., “I like restaurant ABC”) is cached within the caching module 237 while the communication module 233 transmits the identify information (e.g., ABC) to the aggregation module 239.

In one embodiment, the aggregation module 239 is used to associate and/or aggregate other data (e.g., additional geo-coded POI data apart from the location information, geo-coded information, or a combination thereof transmitted by the messaging client 103) obtained from one or more third-party service providers 113, another source accessible over the communication network 105, or a combination thereof with the information the user wants to share related to the at least one item of interest. For example, the aggregation module 239 determines that the at least one item of interest is associated with location information based, at least in part, on the user's input of identification information (name, address, location, etc.) and/or the user's selection of the item of interest using the local search application 115. The aggregation module 239 then processes and/or facilitates a processing of the location information to determine additional geo-coded information from the one or more of the third-party service providers 113. As previously discussed, the geo-coded POI data obtained from one or more of the third-party service providers 113 can have meta-data associated with it such as a building name, a street name, a landmark reference, an area name, a city name, geo-coordinates, etc. In addition, the geo-coded POI data can also contain information such as an email address, a telephone number, and/or a website in some cases. Once the aggregation module 239 obtains the additional geo-coded information related to the item of interest, it is cached within the caching module 237. Further, the aggregation module 239 is also used to determine other information and/or services related to the at least one item of interest (e.g., a web-based mapping service). The other information obtained as a result of the aggregation module 239 is also cached within the caching module 237 prior to its transmission by the communication module 233 to the encoding module 241.

The encoding module 241 is used to encode the information that the user wants to share (e.g., “I like restaurant ABC”) related to at least one item of interest, the location information, the geo-coded information (e.g., name, address, location, etc.), or a combination thereof related to the at least one item of interest, the one or more sharing destinations, the one or more user credentials for the one or more sharing destinations, the additional geo-coded information, and other information and/or services related to the at least one item of interest and generate at least one web link (e.g., a URL link) based, at least in part, on all of this information. The encoding module 241 in connection with the communication module 233 then determines to make the at least one web link available to the one or more sharing destinations selected by the user. As previously discussed, in one example, once the at least one web link is published or posted to one or more sharing destinations by the communication module 233, a user of the sharing destination will be able to view the fact that “user XYZ likes restaurant ABC” and he or she will also be able to click on the web link ABC, which will automatically locate restaurant ABC on a portion of a map provided by one or more of the third-party service providers 113 along with the location and geo-coded information related to that particular item of interest.

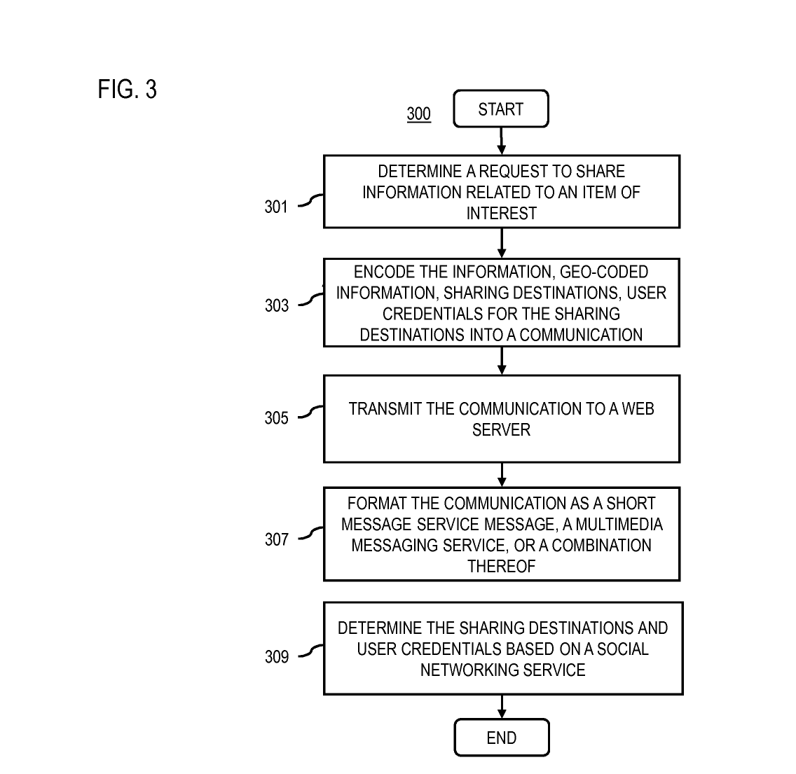

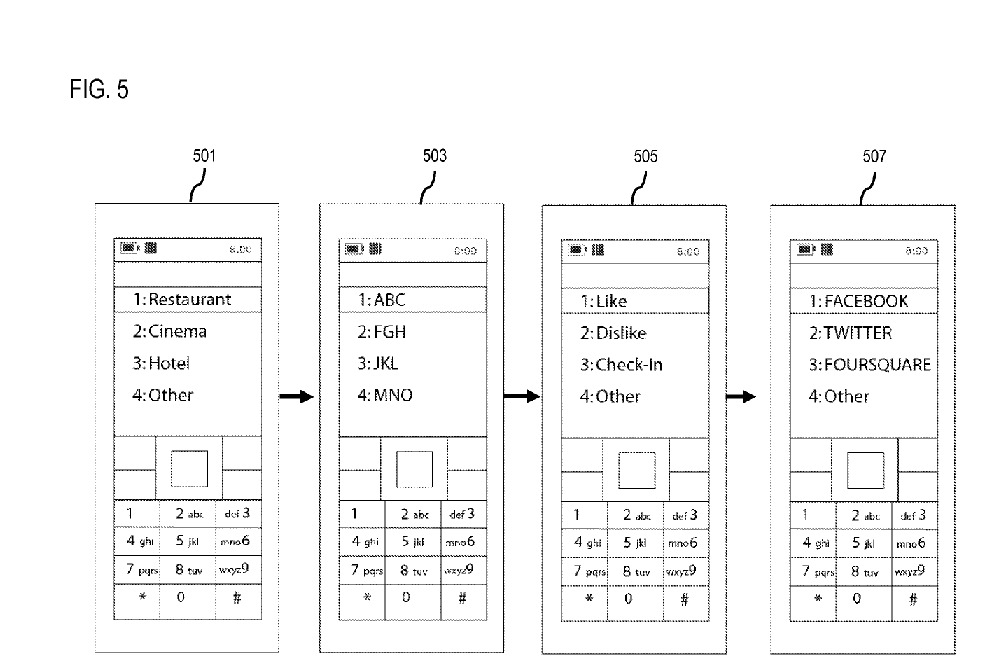

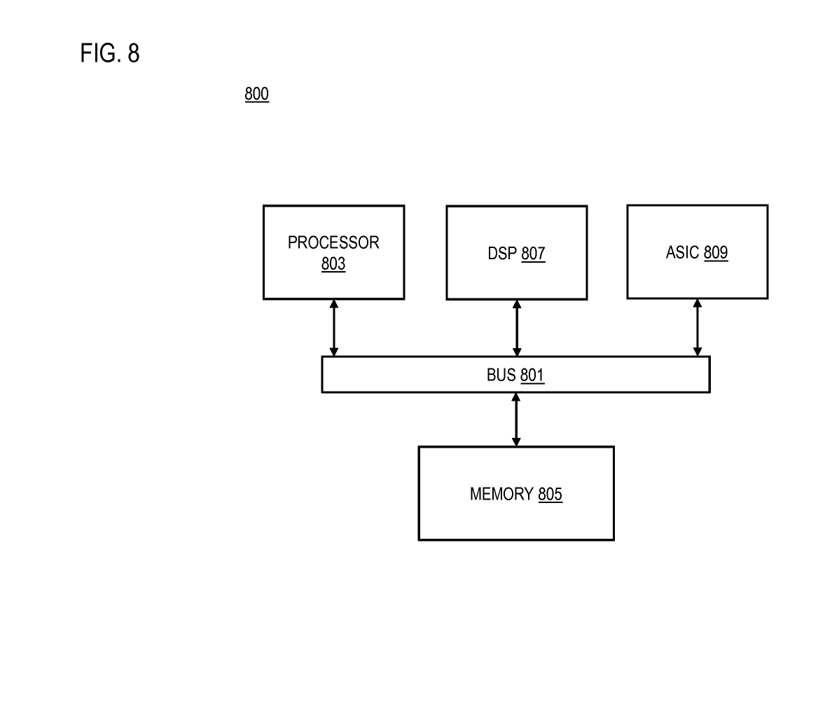

FIG. 3 is a flowchart of a client side process for facilitating the sharing of information related to an item of interest as a web link via one or more data messaging services, according to one embodiment. In one embodiment, the messaging client 103 performs the process 300 and is implemented in, for instance, a chip set including a processor and a memory as shown in FIG. 8. In step 301, the messaging client 103 determines a request to share information related to at least one item of interest. For example, a user of the messaging client 103 may want to share a recent opinion regarding a particular item of interest or a POI (e.g., restaurant ABC). In addition, the information may include location information, geo-coded information, or a combination thereof related to the item of interest. An illustrative example of this process is depicted in FIG. 5.

In step 303, the messaging client 103 causes, at least in part, an encoding of the information, geo-coded information, one or more sharing destinations, one or more user credentials for the one or more sharing destinations, or a combination thereof into at least one communication. In one embodiment, the information could include the information that the user wants to share (e.g., “I like restaurant ABC”) related to at least one item of interest, the location information, the geo-coded information (e.g., name, address, location, etc.), or a combination thereof related to the at least one item of interest. In one example, the sharing destinations could include one or more social networking services (e.g., FACEBOOK, TWITTER, FOURSQUARE, etc.). In order to publish and/or post information at the one or more social networking services, a user's credentials (e.g., login and password) are required to both gain access and to associate the information to be shared with a particular user. As previously discussed, today's mobile devices (e.g., mobile phones and/or smartphones) typically have GPRS that enable users to have mobile access to social networking services and/or search engines. However, in emerging markets a majority of users do not have GPRS enabled phones or smartphones and are therefore limited to voice and data messaging services (e.g., SMS, MMS, etc.). Accordingly, the information that the user wants to share related to an item of interest in an emerging market has to first be encoded in a manner that can be readily transmitted (e.g., SMS, MMS, etc.).

In step 305, the messaging client 103 causes, at least in part, a transmission of the at least one communication to a web server. As previously discussed, the at least one communication is transmitted by the messaging client 103 to the web server 107 via one or more data messaging services (e.g., SMS, MMS, etc.). In step 307, the messaging client 103 causes, at least in part, a formatting of the at least one communication as a Short Message Service message, a Multimedia Messaging Service message, or a combination thereof. A Short Message Service (SMS) message is a text based messaging system that uses standardized communication protocols to allow the exchange of short text messages between devices. As previously discussed, SMS messaging is the primary means of transmitting non-voice data in emerging markets. For example, a user can send a SMS message related to an item of interest as follows: “1 for like,” “2 for dislike,” “3 for check-in,” “4 for FACEBOOK,” “5 for TWITTER,” and so forth. In another embodiment, a user may want to share information related to an item of interest and the user may posses a mobile device that is equipped with a camera and compatible with MMS services. A Multimedia Messaging Service (MMS) message is another form of data messaging, however, MMS messages can also include multimedia content (e.g., photographs, videos, etc.). As a result, the user can share a photograph of the item of interest (e.g., the exterior of a restaurant or a plate of food) along with other information that the user wants to share about the item of interest (e.g., “I like restaurant ABC”).

In step 309, the messaging client 103 determines the one or more sharing destinations, the one or more user credentials, or a combination thereof based, at least in part, on one or more social networking services. By way of example, the one or more social networking services could include FACEBOOK, TWITTER, FOURSQUARE, etc. Moreover, in one example, the one or more user credentials could include login and password information related to the one or more social networking services.

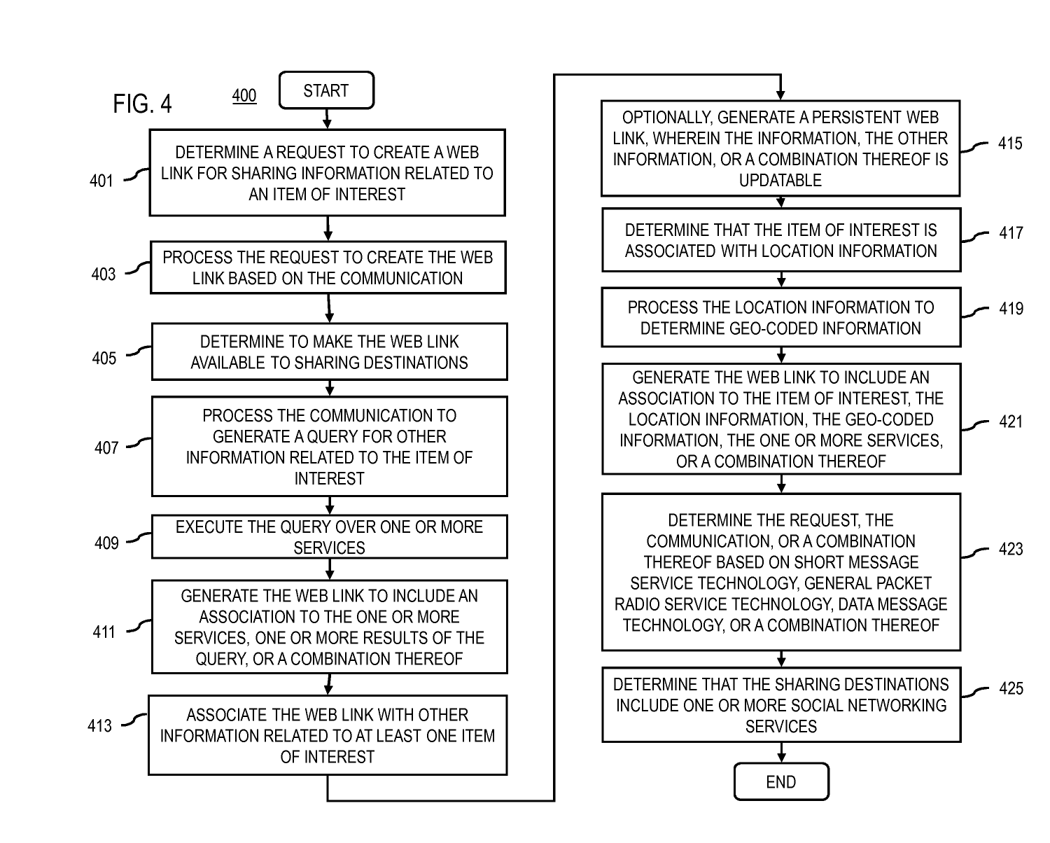

FIG. 4 is a flowchart of a server side process for facilitating the sharing of information related to an item of interest as a web link via one or more data messaging services, according to one embodiment. In one embodiment, the message platform 109 performs the process 400 and is implemented in, for instance, a chip set including a processor and a memory as shown in FIG. 8. In step 401, the message platform 109 determines a request to create at least one web link for sharing information related to at least one item of interest, wherein the request includes at least one communication encoding the information, one or more sharing destinations, one or more user credentials for the one or more sharing destinations, or a combination thereof. As previously discussed, a user may want to share more information related to an item of interest than will fit within the 140-160 character limitation associated with SMS messages. In addition, the user may want to share this information with his or her friends, family, and/associates at one or more social networking services. Accordingly, the user transmits this request from the client side to the server side containing the information that the user wants to share, the one or more destinations to share the information, and the required user credentials (e.g., login and password) to publish or post the information at the one or more sharing destinations.

In step 403, the message platform 109 processes and/or facilitates a processing of the request to cause, at least in part, a creation of the at least one web link based, at least in part, on the at least one communication. Again, one example of the at least one communication could read as follows: “ABC,” “1 for like,” “4 for FACEBOOK,” and so forth. In another example, the at least one communication could read as follows: “ABC,” “1 for lunch specials,” “3 for chicken,” “4 for FACEBOOK,” and so forth. In step 405, the message platform 109 determines to make the at least one web link available to the one or more sharing destinations. As previously discussed, the one or more sharing destinations could include one or more social networking services.

In step 407, the message platform 109 processes and/or facilitates a processing of the at least one communication to cause, at least in part, a generation of at least one query for other information related to the at least one item of interest. In one embodiment, the item of interest is first identified by the user directly (e.g., the user reads a sign on the item's exterior “ABC”) and then enters the information into his or her mobile device. In another example, the user identifies an item of interest using a local search application associated with his or her mobile device. In either case, the initial identification information is then used to generate a query (i.e., a question or inquiry) for other information (e.g., street name, driving directions, etc.) related to that item of interest. This other information may be obtained from one or more third-party service providers (e.g., a web-based mapping service).

In step 409, the message platform 109 causes, at least in part, an execution of the at least one query over one or more services. As previously discussed, in one embodiment the one or more services could include one or more web-based mapping services so that when a user observed and/or clicked on the web link associated with the item of interest, the item of interest could be automatically located on a map. In another example, the one or more services could include music streaming and/or publishing services so that when a user clicks on a web link related to an item of interest (e.g., a music venue) he or she is able to hear the music often associated with that particular item of interest.

In step 411, the message platform 109 causes, at least in part, a generation of the at least one web link to include, at least in part, an association to the one or more services, one or more results of the at least one query, or a combination thereof. As previously discussed, the association of the one or more services, the one or more results of the at least one query, or a combination thereof enable a user to share more information related to the item of interest as opposed to 140-160 characters sent via a data messaging service (e.g., a SMS message).

In step 413, the message platform 109 causes, at least in part, a generation of at least one web link, wherein the at least one web link is further associated with other information related to at least one item of interest. In one example, a user of a mobile device in an emerging market may want to share more information related to an item of interest than what will fit within a single SMS message and may want to generate this information with his or her friends, family, and/or associates. Accordingly, the user can determine to share a web link that references a particular internet resource (e.g., a web-based mapping service) and/or geo-coded information related to the item of interest (e.g., the restaurant's name, address, phone number, etc.) on one or more social networking services (e.g., FACEBOOK) in order to provide his or her friends, family, and/or associates with more detailed information about the item of interest. In another example, a small business owner may want to share detailed information related to his or her restaurant (e.g., weekly lunch specials) with as wide of an audience as possible, but he or she does not already have a website or web presence for his or her small business.

In step 415, the message platform 109 causes, at least in part, the generation of at least one web link, wherein the at least one web link is persistent, and wherein the information, the other information, or a combination thereof is updatable. In one embodiment, the at least one web link may remain published or posted on one or more social networking services, but the information that the web link references may be changed and/or updated from time to time. For example, the information related to an item of interest and the web link could be updated to include additional recommendations and/or opinions as more friends, family, and/or associates of the original user visit the recommended item of interest based on the original user's shared information. In another example, the owner of a small business may want to update the information related to the web link as a form of online advertising.

In step 417, the message platform 109 determines that the at least one item of interest is associated with location information. In one embodiment, the determination of an association between an item of interest and location information can function as a gatekeeper in terms of resource allocation. For example, the user may want to share information related to an item of interest that is commonly associated with location-based information (e.g., a restaurant, a cinema, a hotel, etc.). As such, location-based information, geo-coded information, or a combination thereof can be provided by the messaging client 103 and/or determined by the message platform 109 one or more third-party service providers and the process can continue. In contrast, the user may want to share information related to an item of interest that is not commonly associated with location-based information (e.g., greed, desire, money). As a result, location-based information is not readily available from one or more third-party service providers and the process is terminated. In another embodiment, a user may persist and determine to obtain location-based information related to an item of interest that is not typically associated with location-based information (e.g., turkey, pasta, ice-cream, etc.). In this instance, location-based information related to one or more restaurants that offer the one or more these items (e.g., turkey, pasta, ice cream, etc.) may be obtained from the messaging client 103 and/or one or more third-party service providers and therefore the process can continue.

In step 419, the message platform 109 processes and/or facilitates a processing of the location information to determine geo-coded information. As previously discussed, the geo-coded information is obtained from one or more third-party service providers. For example, the POI data can have meta-data associated with it such as a building name, a street name, a landmark reference, an area name, a city name, geo-coordinates, etc. Moreover, the POI data can also have information associated with it such an email address, a telephone number, and a website in some cases.

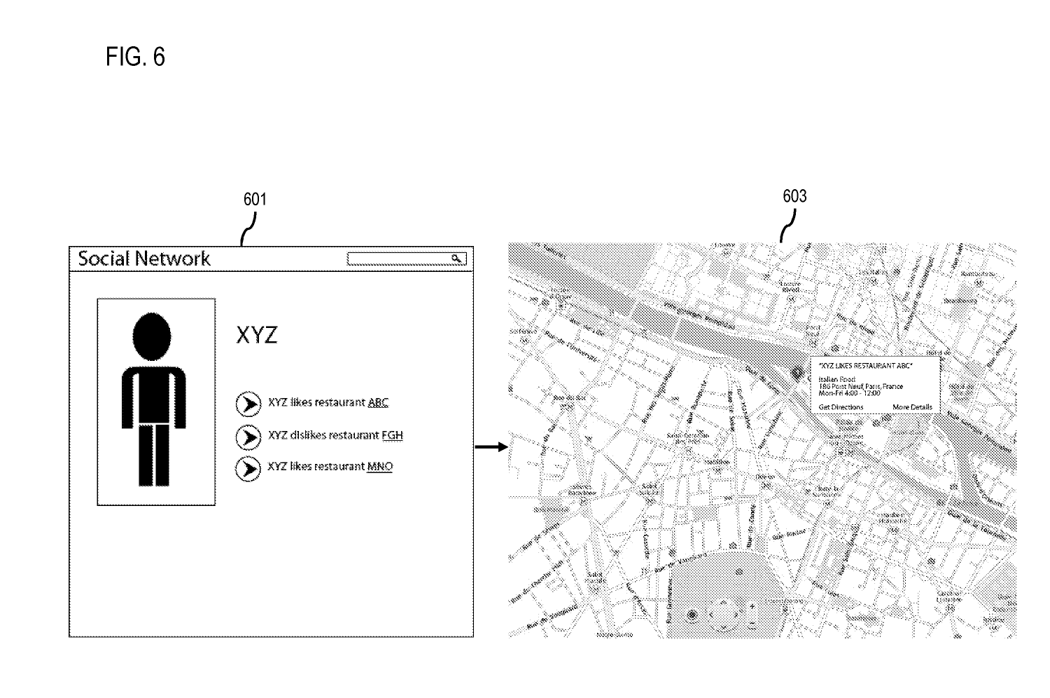

In step 421, the message platform 109 causes, at least in part, a generation of the at least one web link to include, at least in part, an association to at least one item of interest, the location information, the geo-coded information, one or more services, or a combination thereof. For example, the generated web link “user XYZ likes restaurant ABC” can be associated with location information (e.g., the address of restaurant ABC), geo-coded information (e.g., the telephone number of restaurant ABC), and/or one or more services (e.g., a web-based mapping service). In this instance, when a user of a social network service clicks on the web link published or posted on the one or more social networking services, the user is directed to the web-based mapping service where the restaurant ABC is automatically located on a portion of a map along with the location and geo-coded information related to that item of interest. An illustrative example of this process is depicted in FIG. 6.

In step 423, the message platform 109 determines a request and at least one communication, wherein the request, the at least one communication, or a combination thereof is determined based, at least in part, on Short Message Service technology, General Packet Radio Service technology, data message technology, or a combination thereof. In one embodiment, SMS functions as the bearer for the request and the at least one communication because SMS messaging is the primary means of non-voice communication in emerging markets. In another embodiment, particularly outside of emerging markets, GPRS or data message technology could function as the bearer for the request and the at least one communication. For example, outside of emerging markets, if a user's mobile device (e.g., mobile phone) is equipped with a camera and contains a client configured for MMS, which GPRS supports, the user can share a photograph, video, or a combination thereof related to the item of interest (e.g., the exterior of a restaurant or a plate of food) along with the other information that he or she wants to share about the item of interest.

In step 425, the message platform 109 determines to make the at least one web link available to the one or more sharing destinations, wherein the one or more sharing destinations include, at least in part, one or more social networking services. For example, the one or more social networking services could include FACEBOOK, TWITTER, FOURSQUARE, etc.

FIG. 5 is a diagram of user interfaces utilized in the processes of FIGS. 3 and 4, according to various embodiments. As shown, the example user interfaces of FIG. 5 include one or more user interface elements and/or functionalities created and/or modified based, at least in part, on information, data, and/or signals resulting from the processes (e.g., processes 300 and 400) described with respect to FIGS. 3 and 4. More specifically, FIG. 5 illustrates four user interfaces (e.g., interfaces 501, 503, 505, and 507) depicting various client side embodiments. In particular, FIG. 5 depicts how a single SMS communication can be constructed through a series of prompts to incorporate the identity of the item of interest, the information the user wants to share related to that item, and the one or more sharing destinations where the user wants to share this information before it is transmitted as a single SMS to a web server. In one embodiment, the SMS could also include location information, geo-coded information, or a combination thereof associated with the item of interest. As shown in user interface 501, the messaging client prompts a user to select a type of POI to obtain information about and then presents the nearby restaurants based, at least in part, on the user's selection (e.g., restaurants ABC, FGH, JKL, and MNO). In one embodiment, the messaging client can leverage the GPS capability of the mobile device (e.g., mobile phone) to detect the user's location and determine nearby restaurants. In another embodiment, the messaging client can leverage the mobile device's cell-id to detect the approximate location of the device to determine nearby restaurants. The process of leveraging the mobile device's cell-id is particularly applicable in emerging markets where most mobile devices do not have GPS capability.

As shown in user interface 503, the user has requested information about the nearby restaurant ABC. As shown in user interface 505, the messaging client then prompts the user to determine the information that he or she wants to share related to the item of interest. In this case, the user has selected to share the fact that he or she likes restaurant ABC. As shown in user interface 507, the messaging client further prompts the user to determine one or more sharing destinations (e.g., FACEBOOK) to publish or post the information that the user wants to share related to the item of interest.

FIG. 6 is a diagram of an example of a social network service website and a web-based mapping service website utilized in the processes of FIGS. 3 and 4, according to various embodiments. More specifically, FIG. 6 illustrates two websites (e.g., websites 601 and 603) depicting various server side embodiments. In particular, FIG. 6 depicts how a generated web link (e.g., “XYZ likes restaurant ABC”) is published or posted (i.e., made available) at one or more sharing destinations by the web server. As shown in website 601, the user XYZ has determined to share information related restaurants ABC, FGH, and MNO. In addition, each of the web links shared by user XYZ contains a hyperlink (e.g., ABC), which associates the web link with other information, other geo-coded information, one or more services, or a combination thereof. As shown in website 603, once a user of the social network service website 601 clicks on the ABC hyperlink, they are automatically directed a web-based mapping service website 603 that locates the restaurant ABC on a portion of a map along with the information that user XYZ wanted to share, the location information, and the geo-coded information associated with that item of interest. In this instance, a user of the social networking services website 601 and the web-based mapping service website 603 can determine that “XYY likes restaurant ABC,” the restaurant ABC is located at 186 Pont Neuf, Paris, France, specializes in Italian food, and is open for business Monday through Friday, 4:00 p.m. to 12:00 p.m. In addition, the user of the web-based mapping service website 603 is also given the opportunity to “get directions” from the web-based mapping service to restaurant ABC or obtain “more details” related to restaurant ABC from one or more search engines (e.g., GOOGLE).

The processes described herein for facilitating the sharing of information related to an item of interest as a web link via one or more data messaging services may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

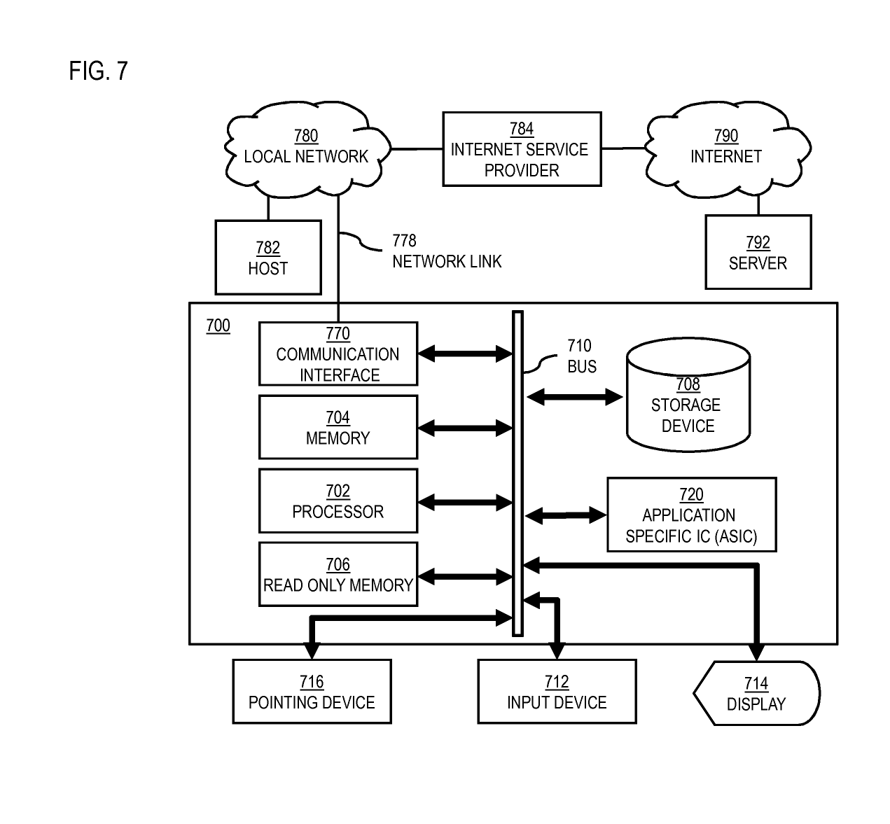

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to facilitate the sharing of information related to an item of interest as a web link via one or more data messaging services as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of facilitating the sharing of information related to an item of interest as a web link via one or more data messaging services.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to facilitate the sharing of information related to an item of interest as a web link via one or more data messaging services. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for facilitating the sharing of information related to an item of interest as a web link via one or more data messaging services. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for facilitating the sharing of information related to an item of interest as a web link via one or more data messaging services, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line.

In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for facilitating the sharing of information related to an item of interest as a web link via one or more data messaging services to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to facilitate the sharing of information related to an item of interest as a web link via one or more data messaging services as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of facilitating the sharing of information related to an item of interest as a web link via one or more data messaging services.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to facilitate the sharing of information related to an item of interest as a web link via one or more data messaging services. The memory 805 also stores the data associated with or generated by the execution of the inventive steps.

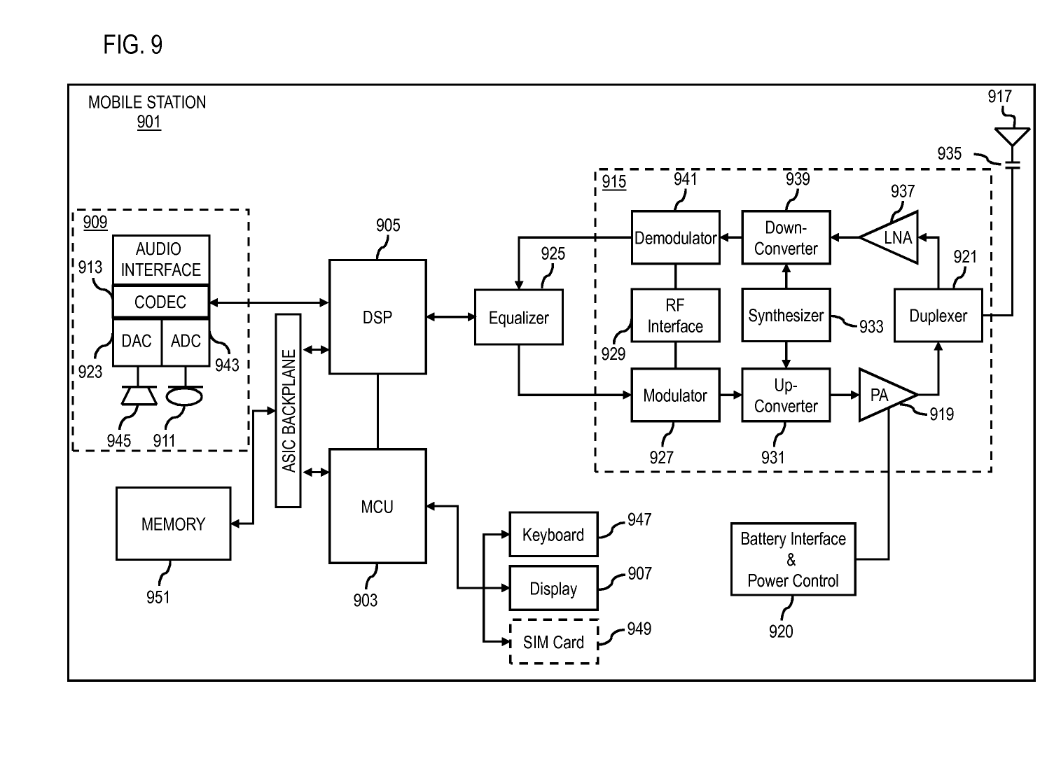

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of facilitating the sharing of information related to an item of interest as a web link via one or more data messaging services. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of facilitating the sharing of information related to an item of interest as a web link via one or more data messaging services. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to facilitate the sharing of information related to an item of interest as a web link via one or more data messaging services. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-28. (canceled)

29. A method comprising:
determining a request to share information related to at least one item of interest;
causing, at least in part, an encoding of the information, geo-coded information, one or more sharing destinations, one or more user credentials for the one or more sharing destinations, or a combination thereof into at least one communication; and
causing, at least in part, a transmission of the at least one communication to a web server.

30. A method of claim 29, further comprising:
causing, at least in part, a formatting of the at least one communication as a Short Message Service message, a Multimedia Messaging Service message, or a combination thereof.

31. A method of claim 29, further comprising:
determining the one or more sharing destinations, the one or more user credentials, or a combination thereof based, at least in part, on one or more social networking services.

32. A method comprising:
determining a request to create at least one web link for sharing information related to at least one item of interest, wherein the request includes at least one communication encoding the information, one or more sharing destinations, one or more user credentials for the one or more sharing destinations, or a combination thereof;
processing and/or facilitating a processing of the request to cause, at least in part, a creation of the at least one web link based, at least in part, on the at least one communication; and
determining to make the at least one web link available to the one or more sharing destinations.

33. A method of claim 32, further comprising:
processing and/or facilitating a processing of the at least one communication to cause, at least in part, a generation of at least one query for other information related to the at least one item of interest;
causing, at least in part, an execution of the at least one query over one or more services; and
causing, at least in part, a generation of the at least one web link to include, at least in part, an association to the one or more services, one or more results of the at least one query, or a combination thereof.

34. A method of claim 32, wherein the at least one web link is further associated with other information related to at least one item of interest.

35. A method of claim 34, wherein the at least one web link is persistent, and wherein the information, the other information, or a combination thereof is updatable.

36. A method of claim 32, further comprising:
determining that the at least one item of interest is associated with location information;
processing and/or facilitating a processing of the location information to determine geo-coded information; and
causing, at least in part, a generation of the at least one web link to include, at least in part, an association to at least one item of interest, the location information, the geo-coded information, one or more services, or a combination thereof.

37. A method of claim 32, wherein the request, the at least one communication, or a combination thereof is determined based, at least in part, on Short Message Service technology, General Packet Radio Service technology, data message technology, or a combination thereof.

38. A method of claim 32, wherein the one or more sharing destinations include, at least in part, one or more social networking services.

39. An apparatus comprising:
at least one processor; and
at least one memory including computer program code for one or more programs,
the at least one memory and the computer program code configured to, with the at least one processor, cause the apparatus to perform at least the following,
determine a request to share information related to at least one item of interest;
cause, at least in part, an encoding of the information, geo-coded information, one or more sharing destinations, one or more user credentials for the one or more sharing destinations, or a combination thereof into at least one communication; and
cause, at least in part, a transmission of the at least one communication to a web server.

40. An apparatus of claim 39, wherein the apparatus is further caused to:
cause, at least in part, a formatting of the at least one communication as a Short Message Service message, a Multimedia Messaging Service message, or a combination thereof.

41. An apparatus of claim 39, wherein the apparatus is further caused to:
determine the one or more sharing destinations, the one or more user credentials, or a combination thereof based, at least in part, on one or more social networking services.

42. An apparatus comprising:
at least one processor; and
at least one memory including computer program code for one or more programs,
the at least one memory and the computer program code configured to, with the at least one processor, cause the apparatus to perform at least the following,
determine a request to create at least one web link for sharing information related to at least one item of interest, wherein the request includes at least one communication encoding the information, one or more sharing destinations, one or more user credentials for the one or more sharing destinations, or a combination thereof;
process and/or facilitate a processing of the request to cause, at least in part, a creation of the at least one web link based, at least in part, on the at least one communication; and
determine to make the at least one web link available to the one or more sharing destinations.

43. An apparatus of claim 42, wherein the apparatus is further caused to:
process and/or facilitate a processing of the at least one communication to cause, at least in part, a generation of at least one query for other information related to the at least one item of interest;
cause, at least in part, an execution of the at least one query over one or more services; and
cause, at least in part, a generation of the at least one web link to include, at least in part, an association to the one or more services, one or more results of the at least one query, or a combination thereof.

44. An apparatus of claim 42, wherein the at least one web link is further associated with other information related to at least one item of interest.

45. An apparatus of claim 44, wherein the at least one web link is persistent, and wherein the information, the other information, or a combination thereof is updatable.

46. An apparatus of claim 42, wherein the apparatus is further caused to:
determine that the at least one item of interest is associated with location information;
process and/or facilitate a processing of the location information to determine geo-coded information; and
cause, at least in part, a generation of the at least one web link to include, at least in part, an association to at least one item of interest, the location information, the geo-coded information, one or more services, or a combination thereof.

47. An apparatus of claim 42, wherein the request, the at least one communication, or a combination thereof is determined based, at least in part, on Short Message Service technology, General Packet Radio Service technology, data message technology, or a combination thereof.

48. An apparatus of claim 42, wherein the one or more sharing destinations include, at least in part, one or more social networking services.

49. A computer program product including one or more sequences of one or more instructions which, when executed by one or more processors, cause an apparatus to at least perform the steps of:
determining a request to share information related to at least one item of interest;
causing, at least in part, an encoding of the information, geo-coded information, one or more sharing destinations, one or more user credentials for the one or more sharing destinations, or a combination thereof into at least one communication; and
causing, at least in part, a transmission of the at least one communication to a web server.
